(19) United States
(12) Patent Application Publication
(10) Pub. No.: US 2014/0178570 A1
(43) Pub. Date: Jun. 26, 2014

(54) POWDER FEEDING DEVICE, BLASTING SYSTEM, AND METHOD FOR MANUFACTURING ELECTRODE MATERIAL

(71) Applicant: NIKON CORPORATION, Tokyo (JP)

(72) Inventors: Toru OHNUMA, Toda-gun (JP); Tatsuya SEKIMOTO, Iwanuma-shi (JP); Junichi IIZAKA, Natori-shi (JP)

(73) Assignee: NIKON CORPORATION, Tokyo (JP)

(21) Appl. No.: 14/189,388

(22) Filed: Feb. 25, 2014

Related U.S. Application Data
(63) Continuation of application No. PCT/JP2012/000255, filed on Jan. 18, 2012.

(30) Foreign Application Priority Data
Aug. 30, 2011 (JP) 2011-187316

(51) Int. Cl. H01M 4/04; B65G 53/46; H01M 4/38

(52) U.S. Cl. CPC H01M 4/0419; H01M 4/386; B65G 53/4608
USPC 427/78; 118/308; 406/122

(57) ABSTRACT

A powder discharge passage (51) formed in a cover member (50) that covers a part of a powder feeding disk (45), and a first gas feeding passage (52) are formed so as to face each other across a gap (GP) between the cover member (50) and the powder feeding disk (45), so as to extend along the bottom surface of a receiver (47) located in the gap (GP).

### CROSS-REFERENCE TO RELATED APPLICATIONS

This is a continuation of PCT International Application No.PCT/JP2012/000255, filed on Jan. 18, 2012, which is hereby incorporated by reference. This application also claims the benefit of Japanese Patent Application No. 2011-187316, filed in Japan on Aug. 30, 2011, which is hereby incorporated by reference.

### BACKGROUND

1. Field

The present invention relates to a powder feeding device and a blasting system, and more particularly to a method for manufacturing electrode material in use of the device and system.

2. Description of Related Art

Various types of powder feeding devices have been commercialized to feed micron-sized powder at a constant speed in a dry environment. For example, a spiral spring type, a drum type and pressure feed/suction type powder feeding devices (e.g. see Japanese Laid-Open Patent Publication No. 2010-65246(A)) are known.

### SUMMARY

In the case of conventional powder feeding devices however, it is difficult to stably feed micron-sized powder for an extremely small predetermined quantity at a time, because of such characteristics of powder as cohesiveness.

With the foregoing in view, it is an object of the present invention to provide a powder feeding device in which the feed quantity of powder is stabilized, a blasting system, and a method for manufacturing an anode and a cathode.

To achieve this object, a powder feeding device according to an aspect of the present invention includes: a storage tank that stores powder; a disk-shaped powder feeding disk that has on the upper surface side of a periphery thereof a receiver that receives powder stored in the storage tank; a rotary driving unit that rotary-drives the powder feeding disk around the rotation symmetric axis of the powder feeding disk; a cover member that covers a part of the powder feeding disk, and forms a gap between the cover member and the powder feeding disk so that the powder received by the receiver can pass through the gap according to the rotation of the powder feeding disk; a first gas feeding passage for feeding first gas to the gap; and a powder discharge passage that is connected with the gap and discharges powder cut out (separated) from the receiver in use of the first gas, and the powder discharge passage and the first gas feeding passage are formed so as to face each other across the gap, and extend along the bottom surface of the receiver located in the gap.

It is preferable that the powder feeding device further includes a powder feeding port into which an outlet end of the powder discharge passage is opened; and a second gas feeding passage for feeding second gas into the powder feeding port.

In the powder feeding device, it is preferable that the powder feeding port has an approximately circular cross-section, and the second gas feeding passage is opened into the powder feeding port in use of a gas feeding nozzle which is coaxial with the approximately circular cross-section.

In the powder feeding device, it is preferable that the receiver is formed in a tapered shape on the upper surface side of the periphery of the powder feeding disk, and the powder discharge passage is formed in a linear shape extending obliquely downward from the gap, and the first gas feeding passage is formed in a linear shape extending obliquely upward from the gap.

In the powder feeding device, it is preferable that the storage tank has a disk holding tank which rotatably holds the powder feeding disk and on which the cover member is disposed, and a powder holding tank which is disposed above the disk holding tank and in which powder is stored, a blade member is rotatably installed inside the powder holding tank, so as to move the powder stored in the powder holding tank, a hole is formed in the bottom of the powder holding tank in a position above the receiver, and the powder stored in the powder holding tank falls through the hole and is received by the receiver by the rotation of the blade member.

A blasting system according to an aspect of the present invention includes: a powder feeding device that feeds powder; and a blasting device that forms a film on a surface of a substrate by mixing the powder fed from the powder feeding device with a jet of gas, and blasting the jet and causing the powder to collide with the substrate, and the powder feeding device according the present invention is used for the powder feeding device.

In the blasting system, it is preferable that the blasting device is directly connected with the powder feeding device.

A method for manufacturing an electrode material according to an aspect of the present invention is a method for manufacturing an electrode material used for a secondary battery, this method including: feeding powder containing active material in use of a powder feeding device; and forming a film on the surface of an electrode substrate by mixing the powder fed from the powder feeding device with a jet of gas, and blasting the jet and causing the powder to collide with the electrode substrate, and the powder feeding device according to the present invention is used for the powder feeding device.

In the method for manufacturing an electrode material, it is preferable that the active material is silicon (Si).

According to the present invention, powder can be stably fed even if the feed quantity of the powder is extremely small.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is a cross-sectional view depicting a feeding pipe and a third tank;

FIG. 2 is a diagram depicting a general configuration of a blasting system according to Embodiment 1;

FIG. 3 is a plan view depicting a powder feeding device according to Embodiment 1;

FIG. 4 is a perspective view depicting the feeding pipe and the third tank;

FIG. 5A is a graph depicting a time-dependent change of powder injection quantity by the powder feeding device of Embodiment 1, and FIG. 5B is a graph depicting a time-dependent change of the powder injection quantity by a conventional powder feeding device;

FIG. 6A is a graph depicting a time-dependent change of the average powder injection quantity by the powder feeding device of Embodiment 1, and FIG. 6B is a graph depicting a time-dependent change of the average powder injection quantity by the conventional powder feeding device;

FIG. 7A is a diagram depicting a general configuration of a lithium ion secondary battery, and FIG. 7B is a diagram (cross-sectional view) depicting a general configuration of an anode for the lithium ion secondary battery;

FIG. 8 is a flow chart depicting a method for manufacturing an anode (or cathode) used for a lithium ion secondary battery;

FIG. 9A is a diagram depicting a general configuration of a blasting system according to Embodiment 2, and FIG. 9B is a cross-sectional view along the arrows IX to IX in FIG. 9A;

FIG. 10 is an enlarged cross-sectional view depicting an area around a blasting device according to Embodiment 2;

FIG. 11 is a perspective view depicting a powder feeding disk according to Embodiment 2;

FIG. 12 is a perspective view depicting a nozzle unit according to Embodiment 2; and

FIG. 13 is a cross-sectional view along the arrows XIII to XIII in FIG. 12.

### DESCRIPTION OF EMBODIMENTS

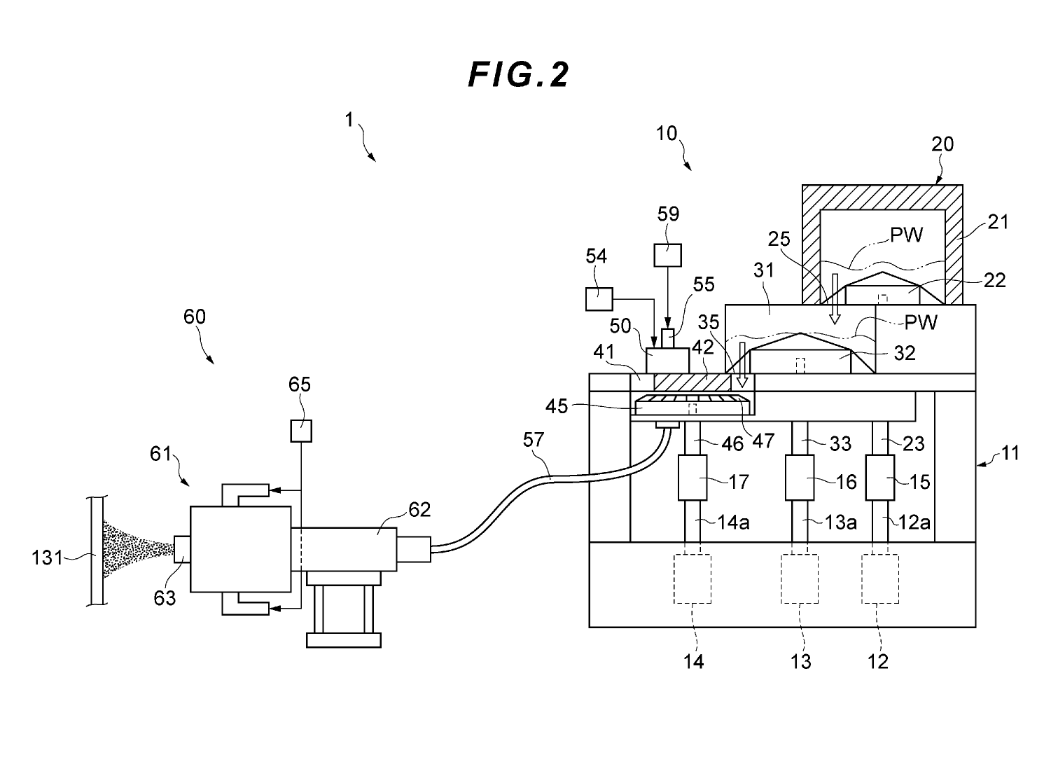

Embodiments of the present invention will now be described. FIG. 2 shows a blasting system 1 according to Embodiment 1, and the blasting system 1 is constituted by a powder feeding device 10 that feeds powder (solid particles) PW, and a blasting device 60 that forms a film on a surface of a substrate (e.g. later mentioned electrode substrate 131) by mixing the powder PW fed from the powder feeding device 10 with a gas jet, blasting with the gas jet and causing the powder to collide with the substrate. The powder feeding device 10 includes a box-shaped case 11, a storage tank 20 that is supported above the case 11 and stores the powder PW, and a powder feeding port 55 that feeds the powder PW stored in the storage tank 20 to an external blasting device 60.

On the inner right side of the case 11 in FIG. 2, a first stepping motor 12 is disposed to rotary-drive a first impeller 22 that is installed in the storage tank 20. A rotary shaft 12a of the first stepping motor 12 extends vertically upward, and the tip of the rotary shaft 12a is connected with a first motor coupling 15. At the inner center of the case 11 in FIG. 2, a second stepping motor 13 is disposed to rotary-drive a second impeller 32 that is installed in the storage tank 20. A rotary shaft 13a of the second stepping motor 13 extends vertically upward, and the tip of the rotary shaft 13a is connected with a second motor coupling 16. On the inner left side of the case 11 in FIG. 2, a third stepping motor 14 is disposed to rotary-drive a powder feeding disk 45 that is installed in the storage tank 20. A rotary shaft 14a of the third stepping motor 14 extends vertically upward, and the tip of the rotary shaft 14a is connected with a third motor coupling 17.

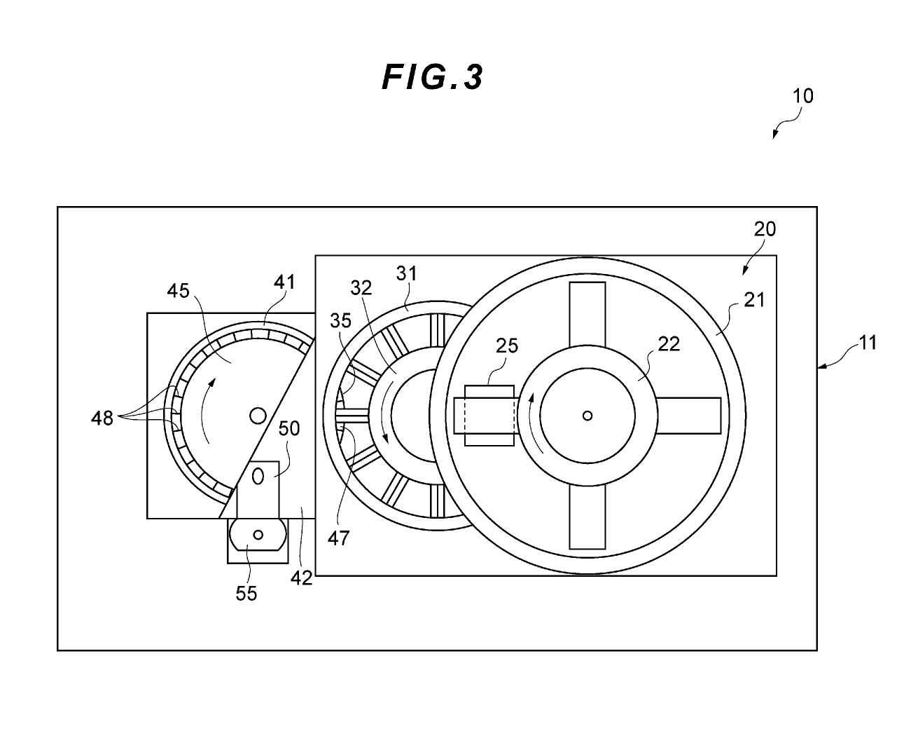

As illustrated in FIG. 2 and FIG. 3, the storage tank 20 is constituted by a first tank 21 located on the top level, a second tank 31 located under the first tank 21 (lower left side in FIG. 2), and a third tank 41 located under the second tank 31 (lower left side in FIG. 2). The first tank 21 is formed into a cylindrical shape with a bottom surface so that the powder PW can be stored, and rotatably holds the first impeller 22 therein, so as to stir the powder PW. The first impeller 22 has a plurality of blade members, and can stir and move the powder PW stored in the first tank 21 by rotating the blade members around the rotation symmetrical axis of the first impeller 22. An upper end of a first driving shaft 23, which extends vertically penetrating the bottom portion of the first tank 21, is connected with the lower center of the first impeller 22. A lower end of the first driving shaft 23 is connected with the first motor coupling 15, whereby the rotary driving force of the first stepping motor 12 is transferred to the first impeller 22 via the first motor coupling 15 and the first driving shaft 23. A hole 25 is formed on the periphery side of the bottom portion of the first tank 21 in a position above the second tank 31, so that the powder PW stored in the first tank 21 falls through this hole 25 and is stored in the second tank 31 by the rotation of the first impeller 22 (blade members).

The second tank 31 is formed into a cylindrical shape with a bottom surface so that the powder PW can be stored, and rotatably holds a second impeller 32 therein, so as to stir the powder PW. The second impeller 32 has a plurality of blade members, and can stir and move the powder PW stored in the second tank 31 by rotating the blade members around the rotation symmetrical axis of the second impeller 32. An upper end of a second driving shaft 33, which extends vertically penetrating the bottom portion of the second tank 31, is connected with the lower center of the second impeller 32. A lower end of the second driving shaft 33 is connected with the second motor coupling 16, whereby the rotary driving force of the second stepping motor 13 is transferred to the second impeller 32 via the second motor coupling 16 and the second driving shaft 33. An arc-shaped hole 35 is formed on the periphery side of the bottom portion of the second tank 31, at a position above a receiver 47 formed on the powder feeding disk 45 of the third tank 41, so that the powder PW stored in the second tank 31 falls through the hole 35 and is received by the receiver 47 of the powder feeding disk 45 by the rotation of the second impeller 32 (blade members).

A detector (not illustrated) to detect a height of the powder PW stored in the second tank 31 is disposed inside the second tank 31. A height detection signal of the height detector is outputted to a controller (not illustrated), and if the height of the powder PW inside the second tank 31, detected by the height detector, is lower than a predetermined height, the controller controls the operation of the first stepping motor 12 so that the first impeller 22 is rotated and the powder PW falls from the first tank 21 into the second tank 31. Thereby the height of the powder in the second tank 31 can be maintained to be within a predetermined range, and the density (dead weight) of the powder PW in the second tank 31 becomes approximately constant, and as a result the quantity (volume and density) of the powder received by the receiver 47 can always be maintained as constant. This controller (not illustrated) also controls the operation of the second stepping motor 13 and the third stepping motor 14 as well.

The third tank 41 is formed into a container shape to contain the powder feeding disk 45 and hold the powder feeding disk 45 therein so as to be rotatable around the rotation symmetrical axis. The powder feeding disk 45 is formed into a disk shape which faces upward inside the third tank 41. An upper end of a third driving shaft 46, which extends vertically penetrating the bottom portion of the third tank 41, is connected with the lower center of the powder feeding disk 45. A lower end of the third driving shaft 46 is connected with the third motor coupling 17, whereby the rotary driving force of the third stepping motor 14 is transferred to the powder feeding disk 45 via the third motor coupling 17 and the third driving shaft 46. A tapered-shaped receiver 47 is formed on an upper face side of the periphery of the powder feeding disk 45, so that the powder PW that fell from the second tank 31 into the third tank 41 through the hole 35 is received. A plurality of partitions 48 is formed on the upper face side of the periphery of the powder feeding disk 45, and these partitions 48 divide the receiver 47 into a plurality of pockets.

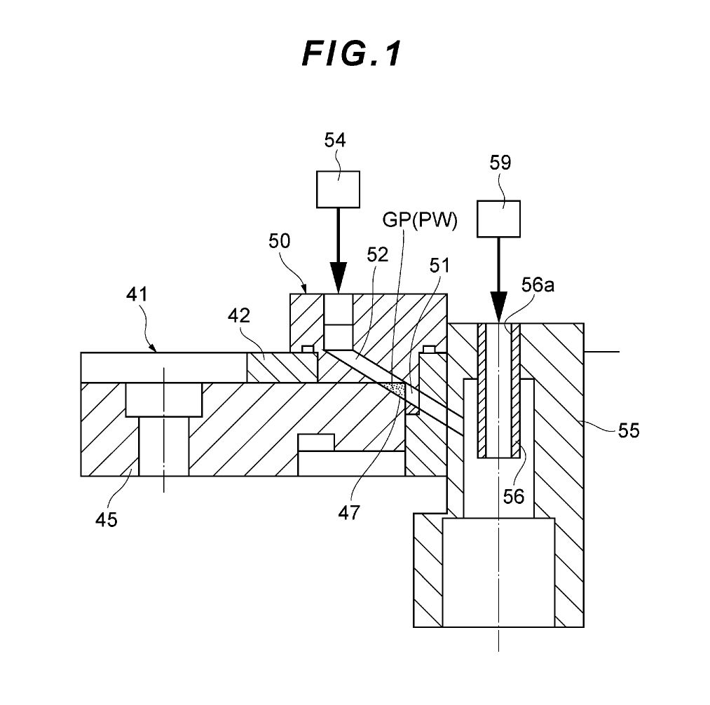

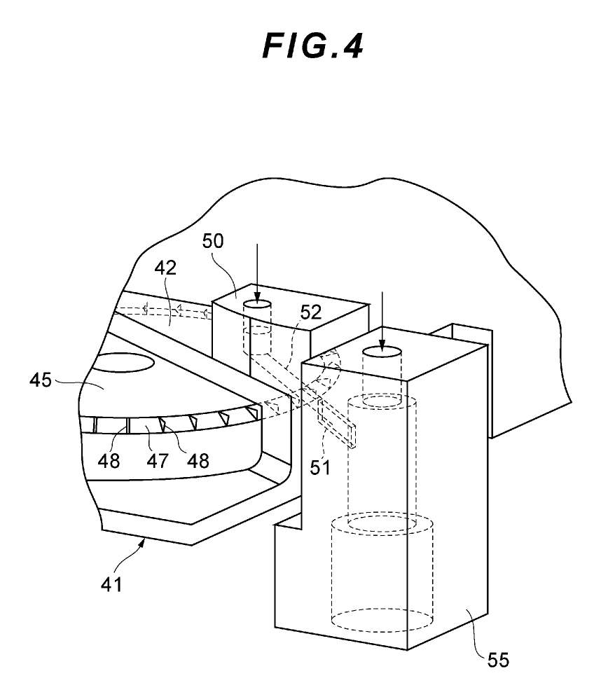

On the third tank 41, a ceiling portion 42 is formed so as to cover a part of the third tank 41, and a cover member 50 that covers an area near the periphery of the powder feeding disk 45 is installed on the ceiling portion 42. As illustrated in FIG. 1 and FIG. 4, the cover member 50 is formed into a block shape that extends over the periphery of the third tank 41 and the ceiling portion 42, and a gap GP, for passing the powder PW received by the receiver 47 according to the rotation of the powder feeding disk 45, is created between the cover member 50 and the powder feeding disk 45. The cross-sectional shape of the gap GP is a right-angled triangle that matches with the shape of the partition 48 of the powder feeding disk 45. A powder discharge passage 51, which guides the powder PW passing through the gap GP into the powder feeding port 55, is formed under the cover member 50. The powder discharge passage 51 is formed into a linear shape that extends obliquely downward from the gap GP, so that the gap GP and the powder feeding port 55 are connected. In other words, the powder discharge passage 51 is formed extending over the lower portion of the cover member 50, the side portion of the third tank 41 and the side portion of the powder feeding port 55, and an inlet end of the powder discharge passage 51 is opened to the gap GP, and an outlet end of the powder discharge passage 51 is opened into the powder feeding port 55.

On the other hand, a first gas feeding passage 52, which feeds gas to the gap GP, is formed in an upper portion of the cover member 50. The upstream side of the first gas feeding passage 52 is formed into a linear shape that extends vertically, and the first gas feeding device 54, which feeds gas into a first gas feeding passage 52, is connected with the upper end of the first gas feeding passage 52. The downstream side of the first gas feeding passage 52 is formed into a linear shape that extends obliquely upward from the gap GP, that is, the first gas feeding passage 52 is bent in the middle. Thus the downstream side of the first gas feeding passage 52 and the powder discharge passage 51 are formed so as to face each other across the gap GP, and extend along the bottom surface of the receiver 47, which is located in the gap GP.

Thereby the first gas fed by the first gas feeding device 54 reaches the gap GP through the first gas feeding passage 52, and collides with the powder PW located in the opening of the first gas feeding passage 52. As a result, the powder PW located in the opening of the first gas feeding passage 52 is cut out (separated) from the receiver 47, and is guided, along with the first gas, from the powder discharge passage 51 to the powder feeding port 55. Since the first gas feeding passage 52 and the powder discharge passage 51 are formed to extend along the bottom surface of the receiver 47 respectively, the force that the powder PW in the receiver 47 receives from the first gas is directed to the powder discharge passage 51 along the bottom surface of the receiver 47, and all of the powder PW is discharged to the powder discharge passage 51 without major problems. The powder feeding disk 45 is constantly rotating at a predetermined angular velocity from the hole 35 of the second tank 31 to the gas feeding passage 52, hence the powder PW is constantly fed to the opening of the first gas feeding passage 52 at a predetermined speed. As a result, the powder PW located in the front end of the powder feeding disk 45 in the rotation direction is continuously cut out (separated), and is discharged to the powder discharge passage 51 at a predetermined discharge speed (discharge quantity per unit time, the same applies hereinafter), so as to feed a fixed quantity of powder. A cross-section of the downstream side of the first gas feeding passage 52 and a cross-section of the powder discharge passage 51 in the extending direction are both narrow rectangles that extend vertically, hence the front end of the stored powder PW is always maintained to be flat, that is, an unexpected breakdown of the powder PW in the receiver 47 can be prevented, and the powder can be stably fed. The first gas fed by the first gas feeding device 54 is, for example, air or a nitrogen, argon, neon or helium gas, and can be selected according to the type of the powder PW or the like.

As illustrated in FIG. 1, the powder feeding port 55 is formed into a tube shape of which cross-section of the inner space is approximately circular and which extends vertically, and the upper end of the powder feeding port 55 is connected with the second gas feeding device 59 which feeds gas into the powder feeding port 55 via a gas feeding nozzle 56, and the lower end thereof is connected with a connection pipe 57 (see FIG. 2), which is connected with the outside. The gas feeding nozzle 56 is formed into a short tube shape which extends vertically inside the powder feeding port 55, and the upper portion of the gas feeding nozzle 56 inter-fits with the upper portion of the powder feeding port 55 so as to be disposed coaxially with the powder feeding port 55. The upper end of the gas feeding nozzle 56 is connected with the second gas feeding device 59, and a second gas feeding passage 56a, which allows the gas fed from a second gas feeding device 59 to pass, is formed inside the gas feeding nozzle 56. The gas feeding nozzle 56 has an outer diameter that is smaller than the inner diameter of the middle portion (and lower portion) of the powder feeding port 55, so that the lower portion of the gas feeding nozzle 56 is positioned near the opening of the powder discharge passage 51 on the inside (middle portion) of the powder feeding port 55.

Thereby the second gas fed from the second gas feeding device 59 passes through the second gas feeding passage 56a in the gas feeding nozzle 56 and reaches the powder feeding port 55, and is guided, along with the powder PW guided from the powder discharge passage 51 into the powder feeding port 55 by the above mentioned first gas, to the outside (blasting device 60) via the powder feeding port 55 and the connection pipe 57. At this time, the powder PW inside the powder discharge passage 51 is suctioned into the powder feeding port 55 side by the ejector effect of the gas, which is ejected from the gas feeding nozzle 56 into the powder feeding port 55. The second gas fed by the second gas feeding device 59 is, for example, air, nitrogen, argon, neon or helium, and is selected according to the type of the powder PW or the like.

As illustrated in FIG. 2, the substrate end of the connection pipe 57 is connected with the powder feeding port 55, and the tip of the connection pipe 57 is connected with the blasting device 60 (external device), so as to guide the powder PW fed from the powder feeding port 55 to the blasting device 60. The blasting device 60 is a blasting device to deposit a film by a powder jet deposition method, and includes, as illustrated in FIG. 2, a nozzle unit 61, an accelerating gas feeding unit 65 that feeds gas for acceleration to the nozzle unit 61, a moving unit (not illustrated) that moves a substrate relative to the nozzle unit 61, and a control unit (not illustrated) that controls the feeding of gas by the accelerating gas feeding unit 65 and the relative movement of the substrate by the moving unit, and is constructed such that the powder (solid particles) PW fed to the nozzle unit 61 is dispersed and accelerated by the gas stream that flows inside the nozzle, and is injected from the tip of the nozzle into the substrate (e.g. later mentioned electrode substrate 131).

The nozzle unit 61 is constituted by a nozzle block 62 which is a substrate, an injection nozzle 63 which is a rectangular hollow pipe of which tip is secured in a state of protruding from the nozzle block 62, and a powder feeding nozzle (not illustrated) which is a rectangular hollow pipe (the vertical opening dimension thereof is smaller than the injection nozzle 63) of which tip is coaxially inserted into the injection nozzle 63 from the substrate end side. In other words, the substrate end of the injection nozzle 63 and the tip of the powder feeding nozzle partially overlap, and a slit type accelerating gas injection passage (not illustrated), of which channel width in the vertical direction is about 0.05 to 0.3 mm, is formed in this overlapping portion. The injection nozzle 63 and the powder feeding nozzle (not illustrated) are formed of an anti-corrosive material, such as ceramic.

In the nozzle block 62, an accelerating gas introduction passage (not illustrated), which is connected with the above mentioned vertical accelerating gas injection passage at the substrate end of the injection nozzle 63, is formed, and the accelerating gas feeding unit 65 is connected with the accelerating gas introduction passage. The gas fed by the accelerating gas feeding unit 65 is, for example, air, nitrogen, argon, neon or helium, and is selected according to the type of the powder (solid particles) PW or the like. In the nozzle block 62, a powder feeding passage (not illustrated), which is connected with the substrate end of the powder feeding nozzle, is also formed, and the connection pipe 57 is connected with the powder feeding passage.

According to the blasting system 1 constructed as described above, if the first impeller 22 (blade members) of the powder feeding device 10 is rotated clockwise (or counterclockwise) in FIG. 3 by the rotary-driving of the first stepping motor 12, the powder (solid particles) PW stored in the first tank 21 is moved while being stirred, then falls through the hole 25 of the first tank 21 and is stored in the second tank 31. Next if the second impeller 32 (blade members) is rotated counterclockwise (or clockwise) in FIG. 3 by the rotary-driving of the second stepping motor 13, the powder PW stored in the second tank 31 is moved while being stirred, then falls through the hole 35 of the second tank 31 and is received by the receiver 47 of the powder feeding disk 45.

Next if the powder feeding disk 45 is rotated clockwise (or counterclockwise) in FIG. 3 by the rotary-driving of the third stepping motor 14, the powder PW, received by the receiver 47 of the powder feeding disk 45, is rotated with the powder feeding disk 45, and reaches the gap GP between the cover member 50 and the powder feeding disk 45. Here as illustrated in FIG. 1, the first gas fed from the first gas feeding device 54 to the first gas feeding passage 52 of the cover member 50 passes through the first gas feeding passage 52 and reaches the gap GP, and expels (pushes out) the powder PW passing through the gap GP into the powder discharge passage 51 side, and is guided, along with the expelled powder PW, from the powder discharge passage 51 to the powder feeding port 55. Further, the second gas fed from the second gas feeding device 59 to the gas feeding nozzle 56 passes through the second gas feeding passage 56a in the gas feeding nozzle 56 and reaches inside the powder feeding port 55, and is guided, along with the powder PW guided from the powder discharge passage 51 into the powder feeding port 55 by the above mentioned first gas, to the blasting device 60 through the powder feeding port 55 and the connection pipe 57. At this time, the powder PW inside the powder discharge passage 51 is suctioned into the powder feeding port 55 side as well by the ejector effect of the gas which is ejected from the gas feeding nozzle 56 into the powder feeding port 55, and is fed to the blasting device 60 in a state of being mixed with the gas from the gas feeding nozzle 56.

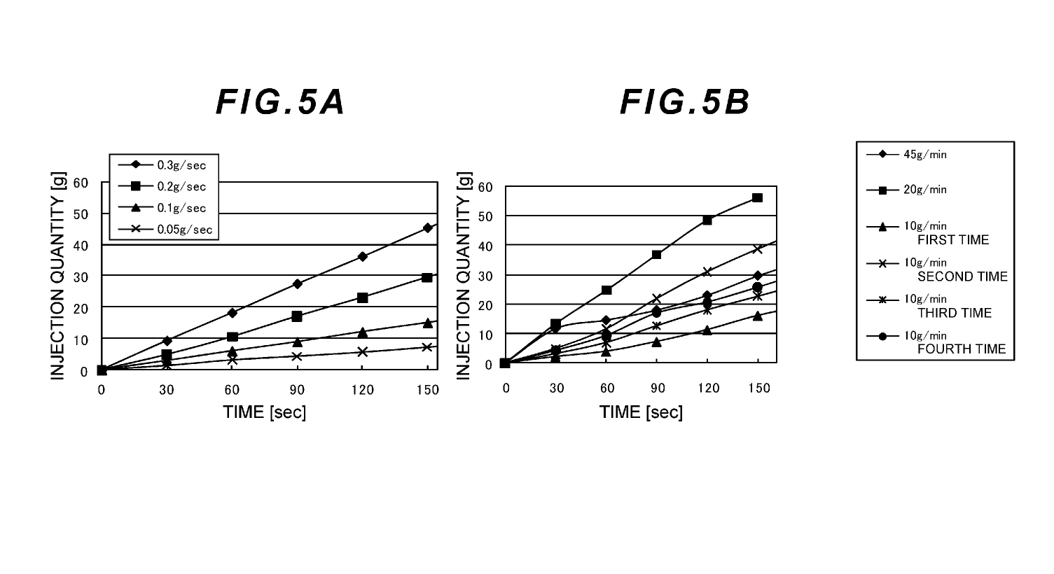

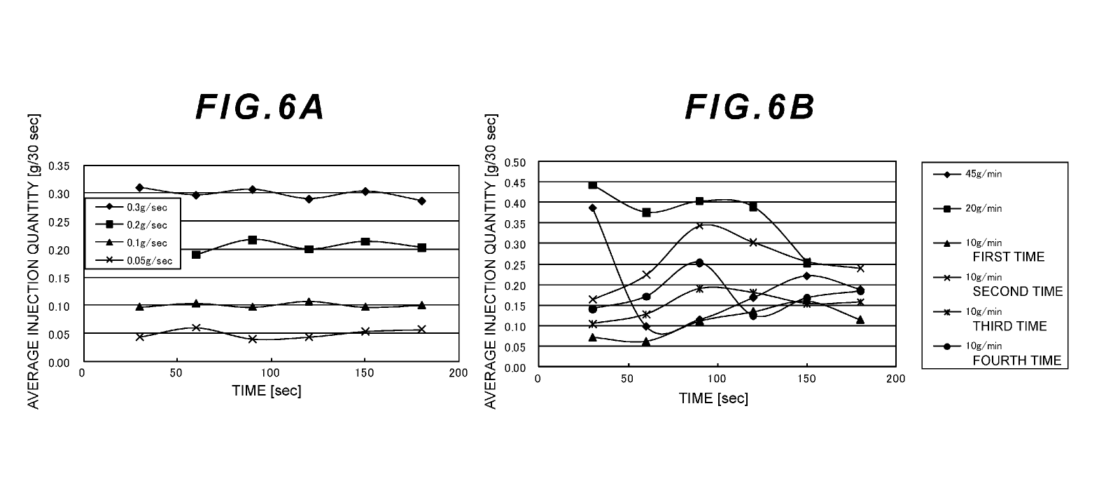

FIG. 5 and FIG. 6 show the results of comparing the performance of the powder feeding device 10 of Embodiment 1 and a conventional powder feeding device. FIG. 5A is a graph depicting a time-dependent change of the powder injection quantity (total feed quantity) by the powder feeding device 10 of Embodiment 1, and FIG. 5B is a graph depicting a time-dependent change of the powder injection quantity (total feed quantity) by the conventional powder feeding device. The powder PW used for experiment is alumina powder. As shown in FIG. 5, compared with the conventional powder feeding device, the powder feeding device 10 of Embodiment 1 can feed the powder PW at a constant feed quantity, even if the feed quantity of the powder PW is extremely small, as indicated by the linearity of the time-dependent powder injection quantity (total feed quantity) (see the graph of which linearity is especially high when the feed quantity is 0.05 g/sec. to 0.3 g/sec.). In the case of the conventional powder feeding device, with which the measurement was performed N=4 times under the same conditions, the measurement results vary greatly, and the repeatability of the powder injection quantity (total feed quantity) of the powder feeding device 10 of Embodiment 1 is higher than that of the conventional powder feeding device.

FIG. 6A is a graph depicting a time-dependent change of the average injection quantity (feed quantity) by the powder feeding device of Embodiment 1, and FIG. 6B is a graph depicting a time-dependent change of the average injection quantity (feed quantity) by the conventional powder feeding device. The average injection quantity (feed quantity) is an average per 30 sec. As shown in FIG. 6, compared with the conventional powder feeding device, the powder feeding device 10 of Embodiment 1 has a very low variation of average injection quantity (feed quantity) when the feeding quantity is in the 0.05 g/sec. to 0.3 g/sec. range, where the average injection quantity (feed quantity) is especially very stable when the injection quantity (feed) is 0.1 g/sec.

Thus according to the powder feeding device 10 of Embodiment 1, the powder discharge passage 51 and the first gas feeding passage 52, which are formed on the cover member 50 covering a part of the powder feeding disk 45, face each other across the gap GP between the cover member 50 and the powder feeding disk 45, and extend respectively along the bottom surface of the receiver 47 located in the gap GP, hence the powder PW received by the receiver 47 located in the gap GP can be expelled (pushed out) in a same direction as the flowing direction of the gas fed from the first gas feeding passage 52, and guided from the powder discharge passage 51 to the powder feeding port 55, whereby the powder PW can be stably fed even if the feed quantity of the powder PW is extremely small.

Further, the powder PW located in the front end of the powder feeding disk 45 in the rotation direction is continuously cut out (separated) and discharged to the powder discharge passage 51 at a constant discharge speed, hence the influence of humidity and aggregability can be minimized and the powder PW can be stably fed even if powder has high aggregability and the feed quantity thereof is extremely small. The feed quantity of the powder PW can easily be controlled by changing the rotation frequency of the powder feeding disk 45, the shape of the receiver 47, and the section sizes of the powder discharge passage 51 and the first gas feeding passage 52.

Furthermore, the second gas feeding passage 56a is opened into the powder feeding port 55 through the gas feeding nozzle 56, which is coaxial with the approximately circular cross-section of the powder feeding port 55, therefore the powder PW can be efficiently guided from the powder discharge passage 51 to the powder feeding port 55 without causing stagnation, adhesion and deposition at the mid path, because of the synergy of the effect of injecting the powder PW from the powder discharge passage 51 to the powder feeding port 55 by the gas fed from the first gas feeding passage 52, and the ejector effect (suction effect) of the gas that is ejected from the gas feeding nozzle 56 to the powder feeding port 55. The powder PW guided from the powder discharge passage 51 to the powder feeding port 55 is mixed with the gas ejected from the gas feeding nozzle 56 by colliding with the wall surface due to the above mentioned injection effect and ejector effect (suction effect), and due to the turbulent flow generated by the sudden tube expansion from the powder discharge passage 51 to the powder feeding port 55, hence the dispersibility of the powder PW can be improved. Further, the pressure of the gas ejected from the gas feeding nozzle 56 can be easily changed and the permissible range of this pressure can be wide, therefore the gas pressure can be flexibly adjusted without being subject to the influence of the powder feeding port 55 from the downstream side (e.g. pressure loss at connection pipe 57 and an external device).

The receiver 47 is formed into a tapered shape on the upper surface side of the periphery of the powder feeding disk 45, and the powder discharge passage 51 is formed into a linear shape extending obliquely downward from the gap GP, and the first gas feeding passage 52 is formed into a linear shape extending obliquely upward from the gap GP, hence the powder PW received by the receiver 47 located in the gap GP can be efficiently expelled (pushed out) in a same direction as the flow direction of the gas fed from the first gas feeding passage 52, and is guided from the powder discharge passage 51 to the powder feeding port 55.

The powder PW stored in the second tank 31 falls through the hole 35 and is received by the receiver 47 by the rotation of the second impeller 32, hence the powder PW can fill the receiver 47 to the maximum by adjusting the rotation frequency or the like of the second impeller 32.

If the powder (solid particles) PW is fed from the powder feeding device 10 to the blasting device 60 as described above, the powder PW mixed with the gas in the powder feeding device 10 reaches inside the injection nozzle 63 in the blasting device 60 through the powder feeding passage (not illustrated) of the nozzle block 62 and the powder feeding nozzle (not illustrated). At this time, the control unit (not illustrated) controls the operation of the accelerating gas feeding unit 65, so as to control the pressure and flow rate of the accelerating gas which is fed from the accelerating gas feeding unit 65 to the nozzle unit 61, whereby the powder PW which was fed from the powder feeding device 10 and reached inside the injection nozzle 63 is accelerated by the accelerating gas and is ejected from the tip of the injection nozzle 63 toward the substrate (e.g. later mentioned electrode substrate 131).

In concrete terms, if the accelerating gas is fed from the accelerating gas feeding unit 65 to the accelerating gas introduction passage (not illustrated) of the nozzle block 62 at a predetermined pressure (˜2 MPa), the accelerating gas is injected into the injection nozzle 63 through the accelerating gas injection passage (not illustrated), and is then ejected from the tip of the injection nozzle 63. At this time, in the outlet area of the accelerating gas injection passage of the injection nozzle 63, a major turbulent flow is generated in front of the outlet of the powder feeding nozzle (not illustrated) because of the ejector effect due to the cross-sectional difference between the injection nozzle 63 and the powder feeding nozzle, the powder PW passing through the powder feeding nozzle is swept into the turbulent flow of the accelerating gas ejected from the accelerating gas injection passage and is dispersed in front of the outlet of the powder feeding nozzle, and is also accelerated by the gas flow and is ejected from the tip of the injection nozzle 63 toward the substrate (e.g. later mentioned electrode substrate 131).

According to the blasting system 1 of Embodiment 1, which includes the powder feeding device 10 which can stably feed the powder (solid particles) PW even if the feed quantity of the powder PW is extremely small, the injection quantity of the powder PW can be maintained to be constant, and efficient and stable processing can be performed even if the injection quantity of the powder PW is extremely small.

The blasting system 1 that deposits a film by the powder jet deposition method was described above, but the cross-sectional shape of the nozzle unit 61 is not limited to a rectangle, but may be another appropriate shape, such as a circle (perfect circle or ellipse), a polygon or a staggered array of circular (rectangular) nozzles. The gas fed from the first gas feeding device 54 and the second gas feeding device 59 or the accelerating gas fed from the accelerating gas feeding unit 65 to the nozzle unit 61 can be appropriately selected, as described above, depending on the processing target, including the substrate and the powder PW. These gases can be a same gas or different types, and the type and mixing ratio of the gases may be changed as the film deposition processing progresses. If the gas to be used is a Group 18 element gas or an inert gas, such as nitrogen, then oxidation of the powder PW in the adhesion process can be suppressed. If a gas of which mass is small, such as helium, is used, the collision velocity of the powder PW can be increased, and if air is used, the film deposition cost can be reduced.

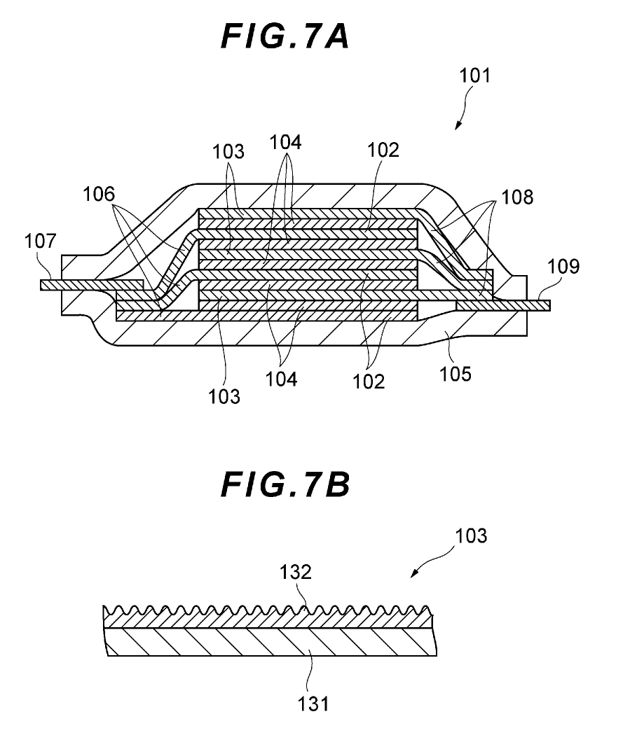

Now a method for manufacturing an anode of a lithium ion secondary battery by depositing a film containing active material onto the surface of an electrode substrate using the blasting system 1 having the above mentioned configuration will be described. First an example of the lithium ion secondary battery will be described with reference to FIG. 7. As illustrated in FIG. 7A, the lithium ion secondary battery 101 is constituted by a cathode 102, an anode 103, a separator 104 which is disposed between the cathode 102 and the anode 103, and a laminate film 105 which encloses these composing elements. The cathode 102, the separator 104 and the anode 103 are formed into a thin film shape respectively, and are laminated in this order, and enclosed, along with an electrolytic solution (not illustrated), in the laminate film 105. In this state, the cathode 102 is electrically connected with a cathode tab 107, which is exposed outside the laminate film 105 via a cathode terminal lead 106, and the anode 103 is electrically connected with an anode tab 109, which is exposed outside the laminate film 105 via an anode terminal lead 108.

For the cathode 102, a known cathode formed by adhering cathode active material, that is lithium transition metal oxide, such as lithium cobalt oxide, to aluminum foil (collector) is used. The cathode 102 faces the anode 103 across the separator 104, and is connected with the anode 103 via the electrolytic solution (not illustrated). For the electrolytic solution (not illustrated), a solution prepared by dissolving known electrolytes (non-aqueous electrolytes), such as LiClO₄ and LiPF₆, in a known solvent, such as propylene carbonate and ethylene carbonate, is used.

As illustrated in FIG. 7B, the anode 103 is constituted by an electrode substrate 131 (collector), and a film 132 which includes an active material and is disposed on one or both surface(s) of the electrode substrate 131 that faces the cathode 102. The electrode substrate 131 is formed into a thin plate using copper foil having high conductivity, for example. The film 132 which includes an active material is constituted by silicon (Si) which becomes an anode active material, Cu₃Si which is an alloy of copper and silicon, and copper (Cu) which becomes a binding material, and bumps are formed on the surface.

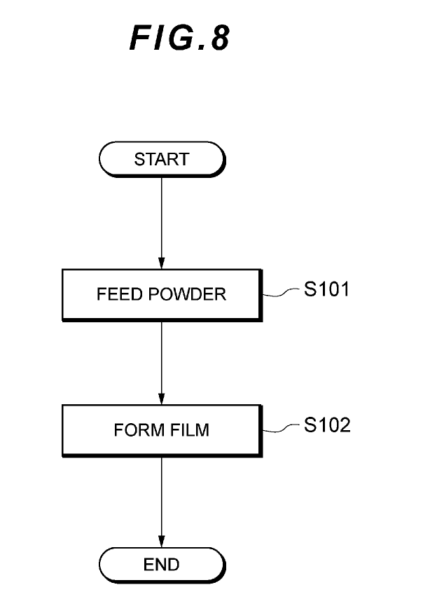

To manufacture the anode 103 of the lithium ion secondary battery 101 constructed as above, the powder (solid particles) PW containing silicon and copper is fed to the blasting device 60 first, using the above mentioned powder feeding device 10, as shown in the flow chart in FIG. 8 (step S101). Then the powder PW is injected under a normal temperature and a normal pressure environment at an injection velocity at or below sound velocity using the blasting device 60, whereby the film 132 of the anode material is formed on the electrode substrate 131 which is a collector (step S102). In other words, the film deposition using the powder jet deposition method is performed. Thereby a stable solid material film, having a simple and flexible configuration, can be formed without using a heating device, an ultrasonic nozzle, a pressure reducing equipment or the like.

The powder (solid particles) PW used for depositing a film of the anode material is formed from silicon (Si), which is an active material having a high capability to form a lithium compound, and copper (Cu) which has conductivity, by a mechanical alloying method. Here “a material having a high capability to form a lithium compound” refers to a material which can easily form an alloy or intermetallic compound with lithium. The mechanical alloying method is a method for manufacturing powder which is alloyed in the mechanical process, where mechanical energy is applied to a mixture of material powder by a high energy ball mill or the like, and the material powder is alloyed in a solid state by repeated crushing and cold rolling. In this embodiment, mechanical energy is applied to a powder mixture of silicon and copper by a ball mill or the like, and the powder mixture is alloyed by repeated crushing and cold rolling, whereby the powder (solid particles) PW, that includes three phases of silicon, copper, and Cu₃Si which is an alloy of copper (Cu) and silicon (Si), is generated.

The injection velocity of the powder PW at this time is mainly set by controlling the type and pressure of the accelerating gas that is fed to the nozzle unit 61, and if the accelerating gas is air, for example, the powder is injected at a velocity at or below sound velocity, that is, at about 50 to 300 m/sec. The powder PW injected with the accelerating gas collides and adheres to the adhering surface (the surface to which the powder PW collides and adheres to, that is, the surface of the electrode substrate (collector) 131 before the film deposition or the film surface of the electrode material during the film deposition) of the electrode substrate 131, which is disposed approximately 0.5 to 2 mm distant from the nozzle tip. At this time, the film 132 of the anode material is formed on the electrode substrate 131 under normal temperature and normal pressure environment by relatively moving the nozzle unit 61 and the electrode substrate 131 while injecting the powder PW.

According to the method for manufacturing the anode 103 used for the lithium ion secondary battery 101 of this embodiment, the powder feeding device 10, which can stably feed the powder PW even if the feeding quantity of the powder (solid particles) PW is very small, is used, hence the injection quantity of the powder PW can be maintained to be constant even if the injection quantity of the powder PW is extremely small, and the film 132 of the anode material can be efficiently and stably formed on the electrode substrate 131 with a small injection quantity of the powder PW.

In this embodiment, the film 132 formed on the anode 103 of the lithium ion secondary battery 101 is constituted by silicon, copper and an alloy of copper and silicon, but the film 132 is not limited to this, and may be constituted by silicon, nickel (Ni) and an alloy of nickel and silicon, for example. With this configuration as well, an effect similar to the above embodiment can be obtained. It is preferable that the alloy of nickel and silicon is constituted by at least one of NiSi, NiSi₂ and a mixture of NiSi and NiSi₂.

In this embodiment, the method for manufacturing the anode 103 of the lithium ion secondary battery 101 by depositing a film which includes an active material on the surface of the electrode substrate using the blasting system 1 was described, but the present invention is not limited to this, and the cathode 102 of the lithium ion secondary battery 101 can be manufactured as well. For example, just like the case of the anode 103, the powder (solid particles) PW containing a lithium alloy material is fed to the blasting device 60 in use of the powder feeding device 10 (step S101), and the powder PW is injected under a normal temperature and normal pressure environment at an injection velocity at or below sound velocity using the blasting device 60, whereby a film of the cathode material is formed on the electrode substrate (step S102). According to the method for manufacturing the cathode 102, an effect similar to the case of manufacturing the anode 103 can be obtained.

The electrode substrate for the cathode (not illustrated) is formed into a thin plate shape using aluminum foil having high conductivity. For the cathode material (material of the film), lithium cobalt oxide (LiCoO₂) to be the cathode active material, for example, can be used. The cathode material is not limited to lithium cobalt oxide, but LiNiO₂, LiMn₂O₄, LiMnO₂, LiₓTiS₂, LiₓV₂O₅, V₂MoO₈, MoS₂, LiFePO₄ or the like can be used.

In this embodiment, the lithium ion secondary battery 101 is formed into a laminate shape, but the lithium ion secondary battery 101 is not limited to this, but may be a cylindrical, a square or a cell shape.

In this embodiment, the method for manufacturing the cathode material and the anode material used for the lithium ion secondary battery 101 was described as an example, but the blasting system of the present invention can be used for manufacturing an electrode material for a secondary battery having other configurations, an electrode material for a primary battery, and an electrode material for a fuel cell, only if the material can be deposited as a film by the powder jet deposition method.

In this embodiment, the storage tank 20 is constituted by the first tank 21, the second tank 31 and the third tank 41, but is not limited to this, and the first tank 21 need not be installed depending on the type of the powder PW. Further, the powder PW may be stored in the third tank 41 without installing the first tank 21 and the second tank 31. The third tank 41 is not limited to the above mentioned configuration including the ceiling portion 42, the cover member 50 and the like, but can be any configuration if a predetermined quantity of the powder PW can filled into a peripheral area of the powder feeding disk 45.

In this embodiment, the gas feeding nozzle 56 is installed inside the powder feeding port 55, but the present invention is not limited to this, and the gas feeding nozzle 56 and the second gas feeding device 59 need not be installed depending on the type of the powder PW.

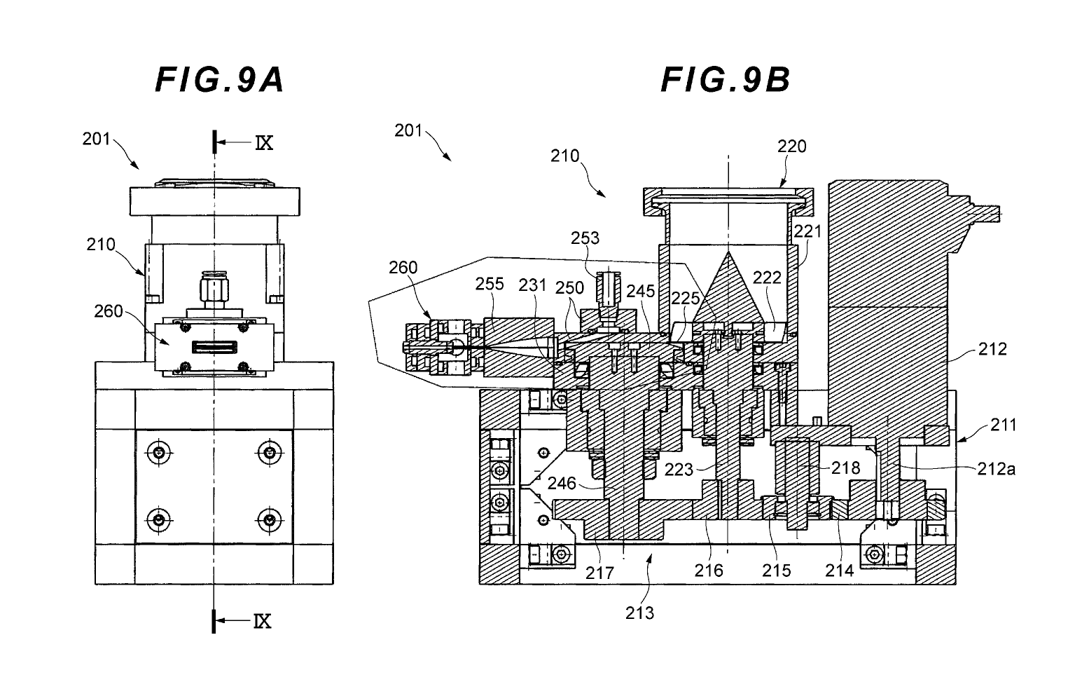

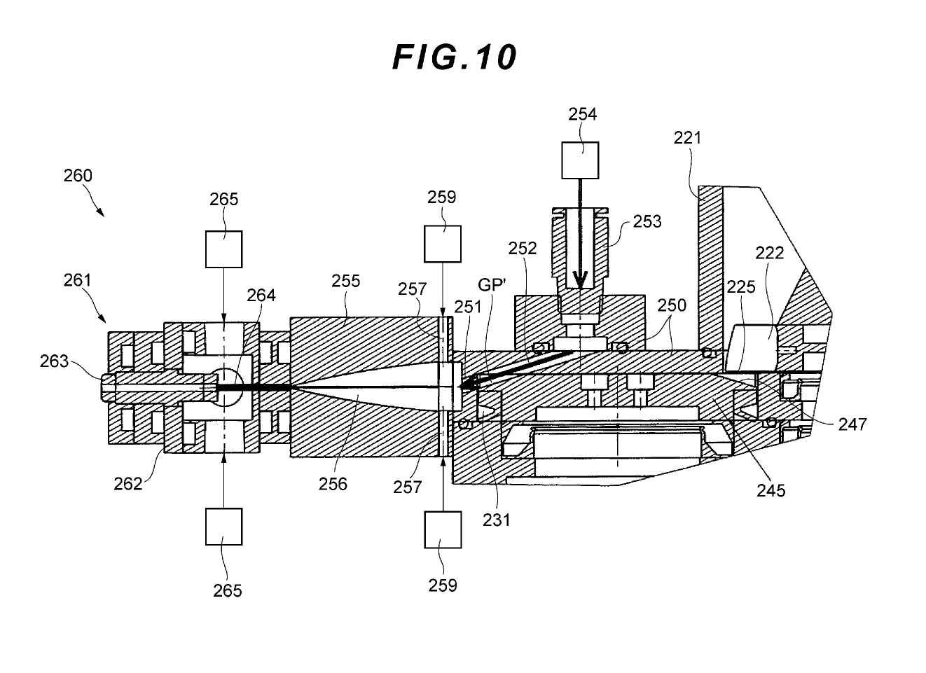

Now Embodiment 2 of the blasting system will be described. As illustrated in FIG. 9, the blasting system 201 according to Embodiment 2 is constituted by a powder feeding device 210 that feeds powder (solid particles) PW, and a blasting device 260 that forms a film on a surface of a substrate (e.g. the above mentioned electrode substrate 131) by mixing the powder PW fed from the powder feeding device 210 with a gas jet, blasting with the gas jet, and causing the powder to collide with the substrate. In FIG. 9 and FIG. 10, the powder PW is omitted. The powder feeding device 210 of Embodiment 2 includes a box-shaped case 211, a storage tank 220 that is supported above the case 211 and stores the powder PW, and a powder feeding port 255 that feeds the powder PW stored in the storage tank 220 to an external blasting device 260.

On the upper rear side of the case 211 (upper right side of the case 211 in FIG. 9), an electric motor 212 is disposed to rotary-drive an impeller 222 that is installed in the storage tank 220 and a powder feeding disk 245. A rotary shaft 212a of the electric motor 212 extends vertically downward, and the tip of the rotary shaft 212a is connected with a gear mechanism 213. The gear mechanism 213 is constituted by a first gear 214, a second gear 215, a third gear 216 and a fourth gear 217.

The first gear 214 is connected with the lower end of the rotary shaft 212a of the electric motor 212, and is engaged with the second gear 215. The second gear 215 is rotatably installed on an intermediate shaft 218 that is disposed inside the case 211, and is engaged with the first gear 214 and the third gear 216. The third gear 216 is connected with the lower end of an impeller driving shaft 223 which is connected with the impeller 222, and is engaged with the second gear 215 and the fourth gear 217. The fourth gear 217 is connected with the lower end of a disk driving shaft 246 which is connected with the powder feeding disk 245, and is engaged with the third gear 216. Thereby the rotary-driving force of the electric motor 212 is transferred to the impeller 222 and the powder feeding disk 245 via the gear mechanism 213.

The storage tank 220 is constituted by an upper tank 221 located on the upper side, and a lower tank 231 located under the upper tank 221 (lower left side in FIG. 9). The upper tank 221 is formed into a cylindrical shape with a bottom surface so that the powder PW can be stored, and rotatably holds the impeller 222 therein, so as to stir the powder PW. The impeller 222 has a plurality of blade members, and can stir and move the powder PW stored in the upper tank 221 by rotating the blade members around the rotation symmetrical axis of the impeller 222. An upper end of the impeller driving shaft 223, which extends vertically penetrating the bottom portion of the upper tank 221, is connected with the lower center of the impeller 222. The third gear 216 is connected with the lower end of the impeller driving shaft 223, whereby the rotary-driving force of the electric motor 212 is transferred to the impeller 222 via the first to third gears 214 to 216 and the impeller driving shaft 223. An arc-shaped hole 225 is formed on the periphery side of the bottom portion of the upper tank 221, at a position above a receiver 247 formed on the powder feeding disk 245 of the lower tank 231, as illustrated in FIG. 10, so that the powder PW stored in the upper tank 221 falls through this hole 225 by the rotation of the impeller (blade members) 222 and is received by the receiver 247 of the powder feeding disk 245.

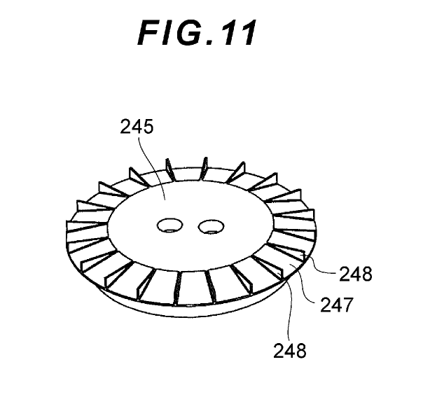

The lower tank 231 is formed into a container shape so that the powder feeding disk 245 can be contained, and holds the powder feeding disk 245 therein so as to be rotatable around the rotation symmetrical axis. The powder feeding disk 245 is formed in a disk shape which faces upward inside the lower tank 231. An upper end of the disk driving shaft 246, which extends vertically penetrating the bottom portion of the lower tank 231, is connected with the lower center of the powder feeding disk 245. The fourth gear 217 is connected to the lower end of the disk driving shaft 246, whereby the rotary driving force of the electric motor 212 is transferred to the powder feeding disk 245 via the first to fourth gears 214 to 217 and the disk driving shaft 246. A tapered-shaped receiver 247 is formed on an upper face side of the periphery of the powder feeding disk 245, so that the powder PW that fell from the upper tank 221 into the lower tank 231 through the hole 225 is received. A plurality of partitions 248 is formed on the upper face side of the periphery of the powder feeding disk 245, as illustrated in FIG. 11, and these partitions 248 divide the receiver 247 into a plurality of pockets.

On the lower tank 231, a cover member 250, to cover an upper part and the periphery of the powder feeding disk 245, is installed. As illustrated in FIG. 10, the cover member 250 is formed into a block shape that constitutes a ceiling portion and a part of the periphery of the lower tank 231, and a gap GP′, for passing the powder PW received by the receiver 247 according to the rotation of the powder feeding disk 245, is created between the cover member 250 and the powder feeding disk 245. The cross-sectional shape of the gap GP′ is a right-angled triangle that matches with the shape of the partition 248 of the powder feeding disk 245. A powder discharge passage 251, which guides the powder PW passing through the gap GP′ into the powder feeding port 255, is formed under the cover member 250. The powder discharge passage 251 is formed in a linear shape that extends obliquely downward from the gap GP′, so that the gap GP′ and the powder feeding port 255 are connected. In other words, the inlet end of the powder discharge passage 251 is opened to the gap GP′, and the outlet end of the powder discharge passage 251 is opened to the inside of the powder feeding port 255 (the later mentioned powder feeding passage 256).

On the other hand, a first gas feeding passage 252, which feeds gas to the gap GP′, is formed in an upper portion of the cover member 250. The upstream side of the first gas feeding passage 252 is formed to into a shape that extends vertically, and is connected with a first gas feeding device 254 that feeds gas into the first gas feeding passage 252 via a gas feeding port 253 disposed in an edge of the upstream side. The downstream side of the first gas feeding passage 252 is formed into a linear shape that extends obliquely upward from the gap GP′, that is, the first gas feeding passage 252 is bent in the middle. Thus the downstream side of the first gas feeding passage 252 and the powder discharge passage 251 are formed so as to face each other across the gap GP′, and extend along the bottom surface of the receiver 247, which is located in the gap GP′.

Thereby the first gas fed by the first gas feeding device 254 reaches the gap GP′ through the first gas feeding passage 252, and collides with the powder PW located in the opening of the first gas feeding passage 252. As a result, the powder PW located in the opening of the first gas feeding passage 252 is cut out (separated) from the receiver 247, and is guided, along with the first gas, from the powder discharge passage 251 into the powder feeding port 255. Since the first gas feeding passage 252 and the powder discharge passage 251 are formed to extend along the bottom surface of the receiver 247 respectively, the force that the powder PW in the receiver 247 received from the first gas is directed to the powder discharge passage 251 along the bottom surface of the receiver 247, and all the powder PW is discharged to the powder discharge passage 251 without major problems. The powder feeding disk 245 is constantly rotating at a predetermined angular velocity from the hole 225 of the upper tank 221 to the gas feeding passage 252, hence the powder PW is constantly fed to the opening of the first gas feeding passage 252 at a predetermined speed. As a result, the powder PW located in the front end of the powder feeding disk 245 in the rotation direction is continuously cut out (separated), and is discharged to the powder discharge passage 251 at a predetermined discharge speed, so as to feed a fixed quantity of powder. A cross-section of the downstream side of the first gas feeding passage 252 and a cross-section of the powder discharge passage 251 in the extending direction are both narrow rectangles that extend vertically, hence the front end of the powder PW is always maintained to be flat, that is, an unexpected breakdown of the powder PW in the receiver 247 can be prevented, and the powder can be stably fed. The first gas fed by the first gas feeding device 254 is the same as the case of Embodiment 1, and is selected according to the type of the powder PW or the like.

The powder feeding port 255 is formed into a tube shape which extends in an approximately horizontal direction, and is installed on a side portion of the lower tank 231. A nozzle unit 261 of the blasting device 260 is directly connected with the tip of the powder feeding port 255. A powder feeding passage 256, which extends in an approximately horizontal direction (longitudinal direction of the powder feeding port 255), is formed at the center inside the powder feeding port 255, so as to connect inside of a powder feeding nozzle 264 of the nozzle unit 261 and the powder discharge passage 251. The surface surrounding the powder feeding passage 256 is formed into a conical surface, so that the outlet end of the powder discharge passage 251 and the inlet end of the powder feeding nozzle 264 can be smoothly connected. A second gas feeding passage 257, which extends vertically from the substrate end of the powder feeding passage 256, is formed in the powder feeding port 255 on the substrate end side and is connected with a second gas feeding device 259, which feeds gas into the second gas feeding passage 257. In FIG. 10, two second gas feeding devices 259 are disposed, but two second gas feeding passages 257 may be connected with one second gas feeding device 259 respectively.

Thereby the second gas fed from the second gas feeding device 259 passes through the second gas feeding passage 257 of the powder feeding port 255 and reaches the powder feeding passage 256, and is guided, along with the powder PW guided from the powder discharge passage 251 into the powder feeding passage 256 by the above mentioned first gas, to the outside (nozzle unit 261 of the blasting device 260) via the powder feeding passage 256. The second gas fed by the second gas feeding device 259 is the same as the case of Embodiment 1, and is selected according to the type of the powder PW or the like.

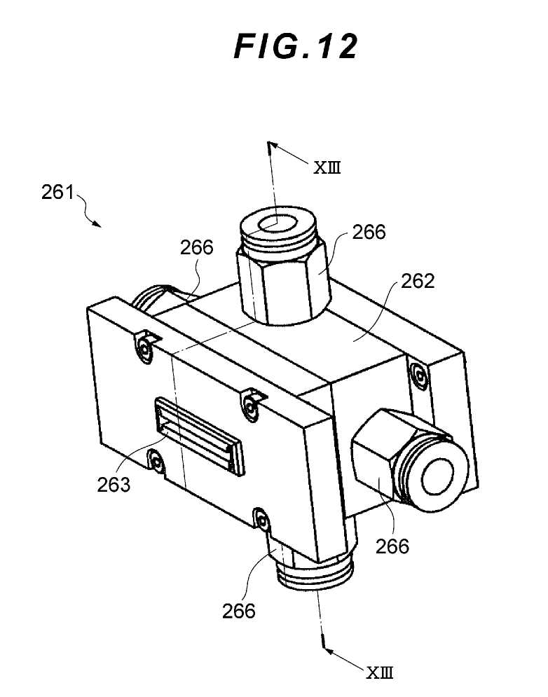

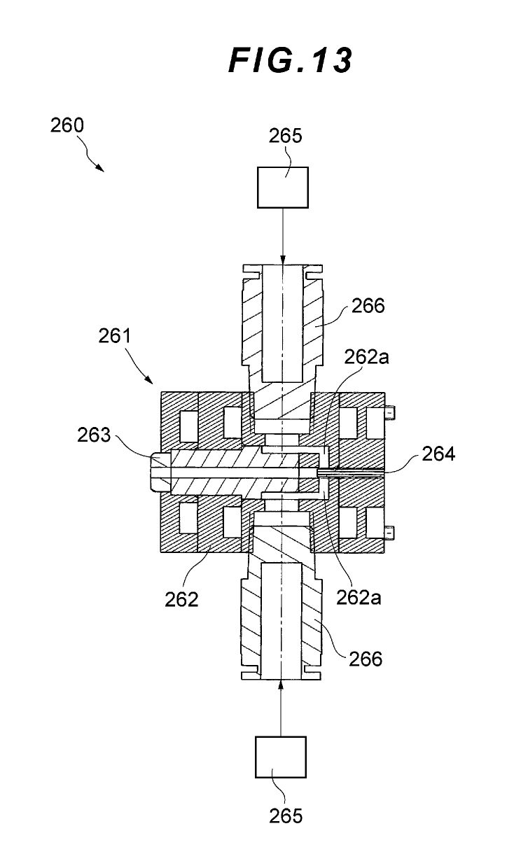

The blasting device 260 according to Embodiment 2 has the same configuration of the blasting device 60 of Embodiment 1, and as illustrated in FIG. 10, includes the nozzle unit 261 and an accelerating gas feeding unit 265. As illustrated in FIG. 12 and FIG. 13, the nozzle unit 261 is constituted by a nozzle block 262 which is a substrate, an injection nozzle 263 which is a rectangular hollow pipe of which tip is secured in a state of protruding from the nozzle block 262, and a powder feeding nozzle 264 which is a rectangular hollow pipe and is disposed coaxially on the substrate end side of the injection nozzle 263. The outer dimension of the powder feeding nozzle 264 is smaller than the opening dimension of the injection nozzle 263, and as illustrated in FIG. 13, the tip of the powder feeding nozzle 264 is slightly inserted into the substrate end side of the injection nozzle 263. An ejection port of the accelerating gas, which is fed into the injection nozzle 263, is formed in the gap between the injection nozzle 263 and the powder feeding nozzle 264.

In the nozzle block 262, four accelerating gas introduction passages 262a, which are connected with the above mentioned accelerating gas ejection port and extend vertically and horizontally, are formed as illustrated in FIG. 13. Each of the four accelerating gas introduction passages 262a is connected with an accelerating gas feeding unit 265 via an accelerating gas feeding port 266 disposed in the upstream end of each accelerating gas introduction passage 262a. Gas fed by the accelerating gas feeding unit 265 is the same as the case of Embodiment 1, and is selected according to the type of the powder (solid particles) PW or the like. In FIG. 10 and FIG. 13, a plurality of accelerating gas feeding units 265 is installed, but the four accelerating gas introduction passages 262a may be connected with one accelerating gas feeding unit 265 respectively. The injection nozzle 263 and the powder feeding nozzle 264 are formed of an anti-corrosive material, such as ceramic. The powder feeding nozzle 264 is connected with the substrate end of the injection nozzle 263, and the powder feeding port 255 of the powder feeding device 210 is connected with the substrate end of the powder feeding nozzle 264.

According to the blasting system 201 constructed as described above, if the impeller 222 (blade members) is rotated in the powder feeding device 210 by the rotary-driving of the electric motor 212, the powder (solid particles) PW stored in the upper tank 221 is moved while being stirred, then falls through the hole 225 of the upper tank 221 and is received by the receiver 247 of the powder feeding disk 245.

At this time, the powder feeding disk 245 is rotated in an opposite direction of the impeller 222 by the rotary-driving of the electric motor 212, and the powder PW received by the receiver 247 of the powder feeding disk 245 is rotated with the powder feeding disk 245, and reaches the gap GP′ between the cover member 250 and the powder feeding disk 245. Here as illustrated in FIG. 10, the first gas fed from the first gas feeding device 254 to the first gas feeding passage 252 of the cover member 250 passes through the first gas feeding passage 252 and reaches the gap GP′, and expels (pushes out) the powder PW passing through the gap GP′ toward the powder discharge passage 251, and is guided, along with the expelled powder PW, from the powder discharge passage 251 to the powder feeding passage 256 in the powder feeding port 255. Further, the second gas fed from the second gas feeding device 259 to the second gas feeding passage 257 in the powder feeding port 255 passes through the second gas feeding passage 257 and reaches the powder feeding passage 256, and is guided, along with the powder PW guided from the powder discharge passage 251 to the powder feeding passage 256 by the above mentioned first gas, to the blasting device 260 through the powder feeding passage 256.

If the powder (solid particles) PW is fed from the powder feeding device 210 to the blasting device 260 as described above, the powder PW mixed with the gas in the powder feeding device 210 reaches the injection nozzle 263 in the blasting device 260 through the powder feeding nozzle 264 of the nozzle unit 261. At this time, the control unit (not illustrated) controls the operation of the accelerating gas feeding unit 265, so as to control the pressure and flow rate of the accelerating gas, which is fed from the accelerating gas feeding unit 265 to the injection nozzle 263 of the nozzle unit 261, whereby the powder PW, which was fed from the powder feeding device 210 and reaches inside the injection nozzle 263, is accelerated by the accelerating gas and is ejected from the tip of the injection nozzle 263 toward the substrate (e.g. the above mentioned electrode substrate 131).

According to the blasting system 201 and the powder feeding device 210 of Embodiment 2, an effect similar to Embodiment 1 can be obtained. Further, the nozzle unit 261 of the blasting device 260 is directly connected with the powder feeding port 255 of the powder feeding device 210, therefore the length of the pipeline from the powder feeding device 210 to the blasting device 260 can be minimized, and responsiveness and stability, when the injection quantity of the powder PW is changed, can be improved. The nozzle unit 261 may also be directly connected with the powder discharge passage 251 of the powder feeding device 210 without passing through the powder feeding port 255.

According to the blasting system 201 of Embodiment 2, an anode (or cathode) of a lithium ion secondary battery can be manufactured in the same manner as Embodiment 1, and an effect similar to Embodiment 1 can be obtained.

In Embodiment 2 described above, the cross-sectional shape of the nozzle unit 261 is not limited to a rectangle, but may be another appropriate shape, such as a circle (perfect circle or ellipse), a polygon or a staggered array of circular (rectangular) nozzles. The gas fed from the first gas feeding device 254 and the second gas feeding device 259 or the accelerating gas fed from the accelerating gas feeding unit 265 to the nozzle unit 261 can be appropriately selected depending on the processing target, including the substrate and the powder PW, just like the case of Embodiment 1.

In the above embodiments, the partitions 48 (248) are disposed in the receiver 47 (247), but the present invention is not limited to this, and the partitions 48 (248) need not be disposed depending on the type of the powder PW or the like.

In the above embodiments, the receiver 47 (247) is formed into a tapered shape on the upper surface side of the periphery of the powder feeding disk 45 (245), but is not limited to this, and may be formed into a gently concave curved surface. In this case, the powder discharge passage and the gas feeding passage may be formed so as to extend in a curved line along the bottom surface of the receiver.

In the above embodiments, the powder feeding device 10 (210) feeds the powder PW to the blasting device 60 (260), which deposits a film by the powder jet deposition method, but is not limited to this, and may feed an extremely small quantity of powder, using carrier gas, to a thermal spraying device, for example, which feeds ceramic powder or the like into plasma along with a carrier gas, and sprays the powder vaporized by the plasma onto a sample disposed in a container to deposit the vaporized powder.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A powder feeding device, comprising:
a storage tank that stores powder;
a disk-shaped powder feeding disk that has on the upper surface side of a periphery thereof a receiver that receives powder stored in the storage tank;
a rotary driving unit that rotary-drives the powder feeding disk around the rotation symmetric axis of the powder feeding disk;
a cover member that covers a part of the powder feeding disk, and forms a gap between the cover member and the powder feeding disk so that the powder received by the receiver can pass through the gap according to the rotation of the powder feeding disk;
a first gas feeding passage for feeding first gas to the gap; and
a powder discharge passage that is connected with the gap and discharges powder cut out (separated) from the receiver in use of the first gas,
the powder discharge passage and the first gas feeding passage being formed so as to face each other across the gap, and extend along the bottom surface of the receiver located in the gap.

2. The powder feeding device according to claim 1, further comprising:
a powder feeding port into which an outlet end of the powder discharge passage is opened; and
a second gas feeding passage for feeding second gas into the powder feeding port.

3. The powder feeding device according to claim 2, wherein
the powder feeding port has an approximately circular cross-section, and
the second gas feeding passage is opened into the powder feeding port in use of a gas feeding nozzle which is coaxial with the approximately circular cross-section.

4. The powder feeding device according to claim 1, wherein
the receiver is formed in a tapered shape on the upper surface side of the periphery of the powder feeding disk, and
the powder discharge passage is formed in a linear shape extending obliquely downward from the gap, and the first gas feeding passage is formed in a linear shape extending obliquely upward from the gap.

5. The powder feeding device according to claim 1, wherein
the storage tank has a disk holding tank which rotatably holds the powder feeding disk and on which the cover member is disposed, and a powder holding tank which is disposed above the disk holding tank and in which powder is stored,
a blade member is rotatably installed inside the powder holding tank, so as to move the powder stored in the powder holding tank,
a hole is formed in the bottom of the powder holding tank in a position above the receiver, and
the powder stored in the powder holding tank falls through the hole and is received by the receiver by the rotation of the blade member.

6. A blasting system, comprising:
a powder feeding device that feeds powder; and
a blasting device that forms a film on a surface of a substrate by mixing the powder fed from the powder feeding device with a jet of gas, and blasting the jet and causing the powder to collide with the substrate, and
the powder feeding device being the powder feeding device according to claim 1.

7. The blasting system according to claim 6, wherein
the blasting device is directly connected with the powder feeding device.

8. A method for manufacturing an electrode material used for a secondary battery, the method comprising:
feeding powder containing active material in use of a powder feeding device; and
forming a film on the surface of an electrode substrate by mixing the powder fed from the powder feeding device with a jet of gas, and blasting the jet and causing the powder to collide with the electrode substrate,
the powder feeding device being the powder feeding device according to claim 1.

9. The method for manufacturing an electrode material according to claim 8, wherein
the active material is silicon (Si).
